(19) United States
(12) Patent Application Publication
(10) Pub. No.: US 2001/0018738 A1
(43) Pub. Date: Aug. 30, 2001

(54) Computer, controlling method therefor, recording medium, and transmitting medium

(75) Inventors: Hidetoshi Mori, Yamato-shi (JP); Takenobu Nakao, Tokyo-to (JP); Ken Sasaki, Yamato-shi (JP); Shunya Uno, Fujisawa-shi (JP); Kazuo Fujii, Yokohama-shi (JP)

Correspondence Address: Andrew J. Wojnicki, Jr., IBM Corporation - MS P386, 2455 South Road, Poughkeepsie, NY, 12601, US

(73) Assignee: International Business Machines Corporation, Armonk, NY (US)

(21) Appl. No.: 09/796,064

(22) Filed: Feb. 28, 2001

(30) Foreign Application Priority Data
Feb. 29, 2000 (JP) 2000-054740

(51) Int. Cl. G06F 9/00; G06F 1/24

(52) U.S. Cl. 713/100

(57) ABSTRACT

A method, apparatus, and computer program device to control an environment for a computer's software execution appropriately to each software program to be executed by a computer are disclosed. While a specific application program is executed, if a volume value, etc. of output voices/sounds are updated, it is confirmed whether to register updated values of the volume, etc. before those values are registered in a volume setting data base so as to be corresponded to a class name of a currently executed application program. In addition, if a focused window on a screen is changed, the class name of the application program corresponding to a new window to be focused is obtained. If a volume value, etc. of the application program are already registered in a volume setting data base, the volume, etc. of the output voices/sounds are updated.

### BACKGROUND

1. Field of the Invention

The present invention relates to a computer, a method for controlling the computer, a recording medium, and a transmitting medium, more particularly to a method for controlling an environment for the computer's software execution, a computer that can employ this method, a recording medium for recording a program that enables the computer to realize the controlling method, and a transmitting medium for transmitting the program enabling the computer to realize the controlling method.

2. Description of Related Art

In recent years, a personal computer (PC) has come to use many software programs that can output such voices/sounds and sounds as effective ones from speakers of the computer. For example, there are some operating systems (OS) provided with a function to output effective sounds in response to such specific processings as starting/ending the system and opening a folder. It is common in game software programs that they output effective sounds so as to give the users so much presence.

However, because the purpose to give the user such presence differs between OS and game software, the proper sound volume is not always the same between the effective sounds of both OS and game software. In addition, there are some users who want to increase the volume during communications via a modem, etc. so as to check the communication state. And, there are also other users who do not hear such the communication sound. A proper value of communication sounds thus differs such way among users. This is why a single PC actually has some software programs whose proper values of output voices/sounds during operation are different from each another.

In contrast, a volume adjusting mechanism of such a PC, as well as a volume adjusting function of some operating systems (OS) are just effective to adjust the volume of voices/sounds output from the speakers of the PC uniformly according to a direction of the user. None of the PC and operating systems is provided with a function for adjusting the volume automatically. Consequently, each time the user starts up a software program, the user must check if the set volume value is appropriate to the started-up software. And, if the user feels it improper, the user must adjust the volume manually. The work has been so troublesome.

In order to solve such a problem, Published Unexamined Patent Application No. 6-131149 discloses a technique for providing a virtual controlling mechanism for adjusting the volume and controlling the right-left volume balance on the display screen, thereby controlling the volume balance between right and left speakers according to the positional information displayed in an image window. This technique can change both volume and right-left volume balance of output voices/sounds by moving the indicators in the image window on the display screen. The technique, however, has been confronted with a problem that it is difficult to change only the positions of those indicators in the image window without changing any volume and right-left volume balance. This is because the positions of those indicators in the image window that can be changed freely by the user originally are related to the volume and the right-left volume balance of output voices/sounds.

Furthermore, just like the above controlling of the volume, etc., the technique has also been confronted with another problem that it is impossible to control other parameters for each software program to be executed by the PC. The parameters are used, for example, to specify an environment for the computer's software execution, that is, a quality of output voices/sounds, a brightness of the PC display screen, an operation speed of the CPU, etc.

Under such circumstances, it is an object of the present invention to provide a computer, a method for controlling the computer, a recording medium, and a transmitting medium that can control an environment for the computer's software execution according to a specific software program executed by the computer.

### SUMMARY OF THE INVENTION

In order to attain the above object, the computer of the present invention is provided with a setting device for setting a proper value of selected system parameters of an environment for the computer's software execution. The selected system parameters can be set for each software program executed by the computer. The system parameter whose proper value is set by the setting device in relation to the environment for the computer's software execution can be, for example, at least any one of a volume control parameter for specifying a volume of output voices/sounds from speakers of the computer; a volume balance control parameter for specifying a volume balance of the output voices/sounds (for example, a volume balance between right and left channels and a volume balance between front and rear channels); a quality control parameter for specifying a quality of the output voices/sounds (for example, a parameter for controlling the volume in each of a plurality of frequency bands and a parameter for converting digital audio data to an analog audio signal); a brightness control parameter for specifying a brightness of the display screen of the computer; and a clock speed control parameter for defining clock speed of a CPU in the computer. This list is exemplary only, and not exclusive. As will be apparent to one of ordinary skill in the art, other parameter choices are possible, in keeping with the spirit and scope of the present invention.

Furthermore, detecting means of the present invention detects a software program executed by the computer and the controlling means controls an environment for the computer's software execution according to a proper value of each system parameter set in accordance with the software program detected by the detecting device. Consequently, when the computer executes a specific software program, the environment for the computer's software execution is controlled appropriately to the specific software program (for example, at least one of the volume, the volume balance, and the quality of output voices/sounds, as well as the brightness of the display screen, and the CPU operation speed is controlled with a proper value), and when the computer executes another software program, the environment for the computer's new software execution is controlled in accordance with the new software program. According to the present invention, therefore, it is possible to control the environment for the computer's software execution appropriately to the software program.

If the computer of the present invention is composed so as to start up a plurality of types of software programs simultaneously, whether or not the corresponding window displayed on the screen of the computer display is active (displayed on the foreground or focused) is checked to detect a software program executed by the computer. Consequently, this makes it easier to control the environment for the computer's detection/execution of the target software program appropriately to the detected software program.

Furthermore, it is possible for the setting device to set a proper value of each system parameter, for example, so as to store the value of each updated system parameter as a proper value of a system parameter for a specific software program if the system parameter is updated according to a user's direction while the computer executes a specific software program, then set the proper value automatically when the software program is started up. Consequently, the user's taste can be reflected in the proper value of the system parameter, as well as the user's labor to set the proper value of each system parameter can be reduced.

The proper value as described above may be set automatically, for example, after confirming the user who has directed updating of a system parameter about whether to set the parameter automatically. And, such a proper value may also be set automatically when the user inputs specific information so as to specify updating of a system parameter (for example, when a specific key on the keyboard is pressed, or the like).

The above setting means may also set a system parameter so that a specified proper value is set as a proper value of the system parameter for a specific software program, for example, if the user selects a specific software program and specifies a proper value of a system parameter for the program. Consequently, the user's taste can be reflected in the proper value of the system parameter.

Furthermore, according to the present invention, it is possible to register a plurality of types of tables for setting a proper value of each system parameter for a software program. And, a plurality of types of such the tables can be registered so as to control an environment for computer's software execution according to the proper value of each system parameter set in any specified one of those tables. Consequently, if there are a plurality of users related to the computer of the present invention, it is possible for each of those users to generate such a parameter setting table so as to enable the present user to specify his/her table. Consequently, the present user's taste can be reflected in the computer's execution environment easily for executing his/her software program.

Furthermore, it is possible to generate a parameter setting table for each scene where the user uses the computer of the present invention (for example, in an office, at home, at a commuting time). And, if the user specifies a setting table corresponding the subject scene, the computer can execute the object software program in an execution environment appropriately to the specified scene.

The method for controlling the computer of the present invention enables a proper value of each system parameter related to an environment of the computer for executing a software program to be set for the software program, the software program executed by the computer to be detected, and the environment of the computer's software execution to be controlled according to a proper value of each of the system parameters set in accordance with the detected software program. Consequently, the computer can control the environment of its software execution according to the subject software program just like the computer of the present invention.

The recording medium of the present invention records a program executed by a computer so as to realize the method for controlling the computer of the present invention. The method comprises a first step of setting a proper value of each system parameter related to an environment for the computer's software execution for each software program; a second step of detecting the software program executed by the computer; and a third step of controlling the environment for the computer's software execution according to the proper value of each system parameter set in accordance with the detected software program. Consequently, if the computer executes the program read from the recording medium, it is possible to control the environment for the computer's software execution appropriately to the software program just like the controlling method of the present invention.

The transmitting medium of the present invention transmits a program for realizing the controlling method of the present invention with use of a computer. Concretely, the method of the present invention comprises the first step for setting a proper value of each system parameter related to an environment for a computer's software execution for each software program; the second step for detecting the software program executed by the computer; and the third step for controlling the environment for the computer's software execution according to a proper value of each system parameter set in accordance with the detected software program. Consequently, if the computer executes the program, which is transmitted by the transmitting medium and stored temporarily in the memory, it is possible to control the environment for the computer's software execution appropriately to the subject software program executed by the software program.

### BRIEF DESCRIPTION OF THE DRAWINGS

The subject matter which is regarded as the invention is particularly pointed out and distinctly claimed in the concluding portion of the specification. The invention, however, both as to organization and method of practice, together with further objects and advantages thereof, may best be understood by reference to the following description taken in connection with the accompanying drawings in which:

FIG. 1 is a schematic block diagram of a computer system per a preferred embodiment of the present invention;

FIG. 2 is a perspective external view of a notebook-type PC;

FIG. 3 is a concept chart of both software and hardware for adjusting an output of voices/sounds, a volume, etc. of output voices/sounds, per preferred embodiments of the present invention;

FIG. 4(A) is an image of a volume adjusting window,

FIGS. 4(B) and (C) are images of changes of focused windows, per preferred embodiments of the present invention;

FIG. 5 is a flow chart for the contents of a volume control processing per preferred embodiments of the present invention; and

FIG. 6 shows (A) how a preferred embodiment of the present invention is realized by an application program, (B) how a preferred embodiment of the present invention is realized by an OS, and (C) how some of the functions of a preferred embodiment of the present invention are realized with use of an interface supplied by BIOS.

### DETAILED DESCRIPTION OF THE INVENTION

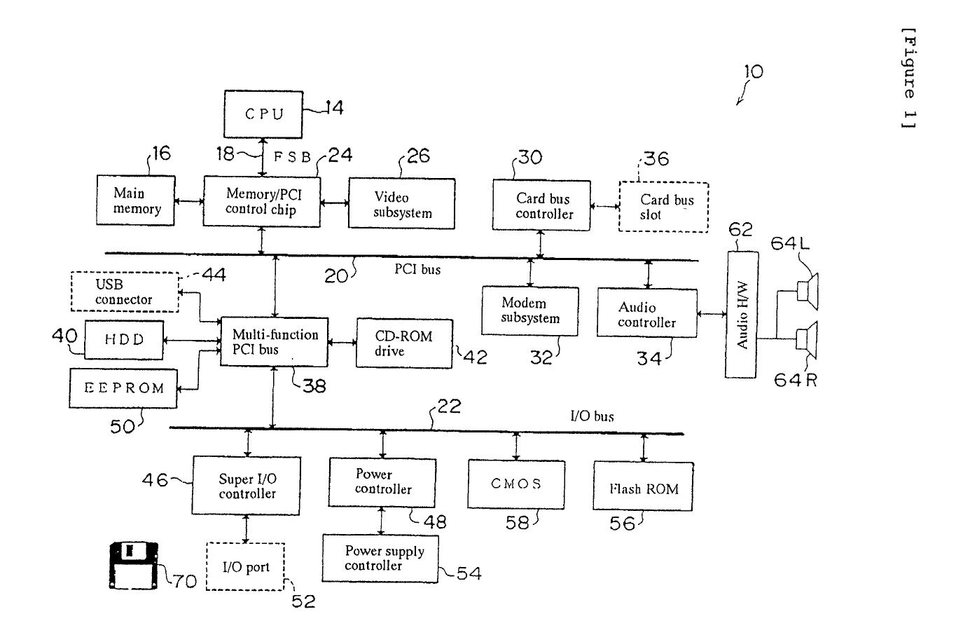

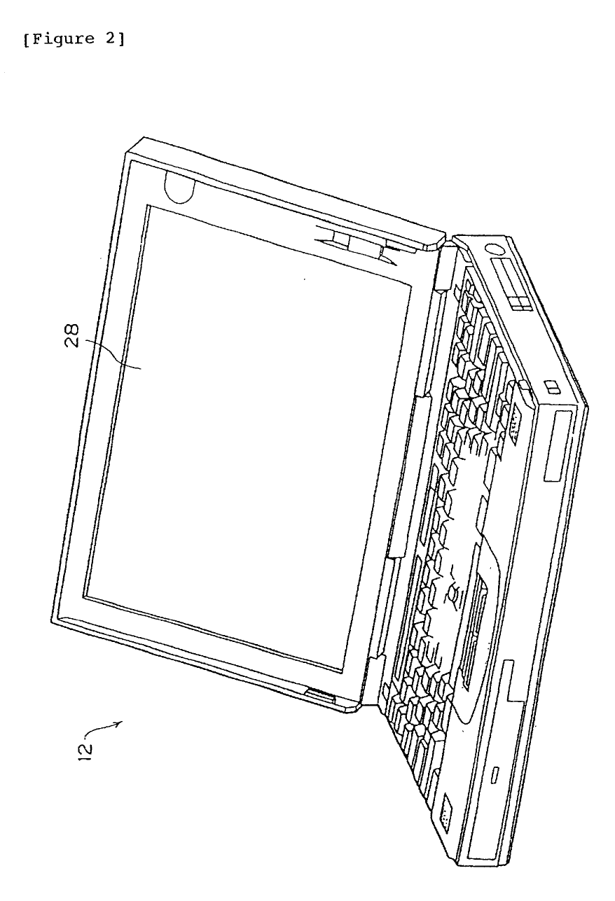

Hereunder, a preferred embodiment of the present invention is described in detail, with reference to the accompanying drawings. FIG. 1 shows a hardware block diagram of a computer system 10 composed of a typical personal computer (PC) preferred to realize the present invention. In FIG. 1, the hardware configuration of the computer system 10 is divided into subsystems in an explanatory view. The PC 12 (FIG. 2) used to realize the present invention conforms to the OADG (PC Open Architecture Developer's Group) specifications and employs “Windows 98” or “Windows NT” (Microsoft USA) or “OS/2” (IBM USA) as an operating system (OS). Although a notebook-type PC is shown as an example in FIG. 2, the present invention may also apply to a desk top type PC. Hereunder, each part of the computer system 10 will be described.

A CPU 14 functions as the brain of the whole computer system 10. The CPU 14 executes various programs under the control of an OS. The CPU 14 may be, for example, a CPU chip of “Pentium,” “MMX Technology Pentium,” or “Pentium Pro” (Intel Inc., USA), or a CPU chip of any other companies, such as AMD, Inc, etc. It may also be a PowerPC (IBM Inc., USA).

The CPU 14 is connected to each hardware component of the computer (to be described later) via a three-layer I/O bus 22 composed of an FSB18, which is a bus connected directly to the external pins of the CPU 14 itself, a PCI (Peripheral Component Interconnect) bus 20, which is used for fast I/O devices, and an ISA (Industry Standard Architecture) bus, which is used for slow I/O devices, etc.

The FSB 18 and the PCI bus 20 are connected to each other via a bridge circuit referred generally to as a memory/PCI control chip 24. The memory/PCI control chip 24 in this embodiment includes a memory controller function for controlling the access to the main memory 16, a data buffer function for managing a difference in the data transfer rate between the FSB 18 and the PCI 20, etc. For example, the memory/PCI control chip 24 may be 440EX, 440GX, etc. (Intel, Inc.) The main memory 16 is a recordable memory used as a work area in which executable programs of the CPU 14 are read or executable program processing data is written.

Executable programs mentioned here include such operating systems (OS) as Windows98, various device drivers for operating peripheral devices, application programs dedicated to specific business activities, and such firmware as BIOS (Basic Input/Output System: a program for controlling I/O operations of such hardware units as a keyboard, a floppy disk drive, etc.) stored in a flash ROM 56 (to be described later in detail).

The video subsystem 26 is used to execute video-related functions and it includes a video controller for actually processing drawing instructions from the CPU 14, writing the processed drawing information in a video memory (VRAM) temporarily, and reading the drawing information from the VRAM so as to display it on a liquid crystal display (LCD) 28 (FIG. 2) as drawing data. The PCI bus 20 is connected to a card bus controller 30, a modem subsystem 32, and an audio controller 34. The modem subsystem 32 is connected to such communication lines as a LAN, a telephone line, etc. The audio controller 34 is connected to an audio hardware circuit 62 (hereafter, to be referred to as an audio H/W 62) and the audio H/W 62 is connected to a pair of speakers 64L and 64R. The audio H/W 62 has a D/A converter and an amplifier (both not illustrated) in itself. The audio H/W 62, if voice data is entered from the audio controller 34, converts the voice data to an analog voice signal, then amplifies the signal so as to be output to the speakers 64L and 64R.

The PCI bus 20 and the I/O bus 22 are connected to each other via a multi-function PCI device 38. The multi-function PCI device 38 is provided with a bridge function for connection between the PCI bus 20 and the I/O bus 22, a DMA controller function, a programmable interrupt controller (PIC) function, a programmable interval timer (PIT) function, an IDE (Integrated Drive Electronics) interface function, a USB (Universal Serial Bus) function, and an SMB (System Management Bus) interface function. The multi-function PCI device 38 may be, for example, a device referred to as PIIX4 (Intel, Inc.).

The IDE interface realized with the IDE interface function is connected to an IDE hard disk drive (HDD) 40. An IDE CD-ROM drive 42 is also connected to the IDE interface through an ATAPI (AT Attachment Packet Interface). The multi-function PCI device 38 is provided with a USB port, which is connected to a USB connector 44 provided on, for example, a wall, etc. of the PC body. In addition, the multi-function PCI device 38 is connected to an EEPROM 50 via an SM bus. The EEPROM is a memory for holding such information items as the user-registered password, the supervisor password, the serial number of the product, etc. It is non-volatile and enables stored data to be rewritable electrically.

The I/O bus 22 is lower in data transfer rate than the PCI bus 20. (Actually, the bus 22 is 16 bits in bus width and 4 MBps in maximum data transfer rate.) The I/O bus 22 is used to connect such comparatively slow peripheral devices (not illustrated) as a super I/O controller 46, a power controller 48, a flash ROM 56 composed of an EEPROM, a CMOS 58, a real time clock (RTC), a keyboard/mouse controller, etc.

The super I/O controller 46 connected to an I/O port 52 is a peripheral controller used to drive a floppy disk drive (FDD) and control the I/O operations of parallel data (PIO) via a parallel port and the I/O operations of serial data (SIO) via a serial port. The power controller 48 is mainly used for both power management and thermal management of the computer system 10. The power controller may be composed of a single multi-chip microcomputer provided with an MPU, a RAM, a ROM, a timer, etc.

The flash ROM 56 is a memory for holding such firmware programs as a BIOS, a boot strap code, etc. It is a non-volatile memory in which the stored data can be updated electrically. The CMOS 58 is composed of a non-volatile semiconductor memory connected to a backup power supply. It functions as a non-volatile fast storing device.

In order to compose the computer system 10, many more electric circuits are needed in addition to those shown in FIG. 1. However, those electrical circuits are already well known to those skilled in the art and they are not substantial components of the present invention. The description for them will therefore be omitted here. In addition, only part of the connections between hardware units are shown in FIG. 1, simplifying the drawing.

Next, a description will be made for an embodiment of a method for controlling the computer of the present invention. The method controls the volume of voices/sounds output from the speakers 64L and 64R of the computer system 10, as well as the volume balance between those two speakers 64L and 64R. In this embodiment, at first, a volume control program of the present invention is stored in an information recording medium 70 (FIG. 1) together with other application programs. In FIG. 1, the information recording medium 70 is a floppy disk. However, it may be such an information recording medium as a CD-ROM, etc. While the information recording medium 70 is loaded in a drive (a floppy disk drive or a CD-ROM drive), the volume control program, etc. are read from the information recording medium by the medium-loaded drive in response to an install command from the information recording medium. The programs are then stored in the HDD 40.

The volume control program in this embodiment is read from the HDD 40 together with other application programs and loaded into the main memory 16 automatically when the computer system 10 is powered and the OS is started up. The application programs loaded into the main memory 16 together with the volume control program are also started when the computer system 10 is powered. The volume control program and each of the other loaded programs are executed by the CPU 14 sequentially. Consequently, the PC 12 functions as the computer of the present invention. The information recording medium storing the volume control program and other application programs thus corresponds to the recording medium of the present invention.

Next, a description will be made for how to change the output of voices/sounds, the volume of the output voices/sounds from the speakers 64L and 64R, before describing the processing with use of the volume control program.

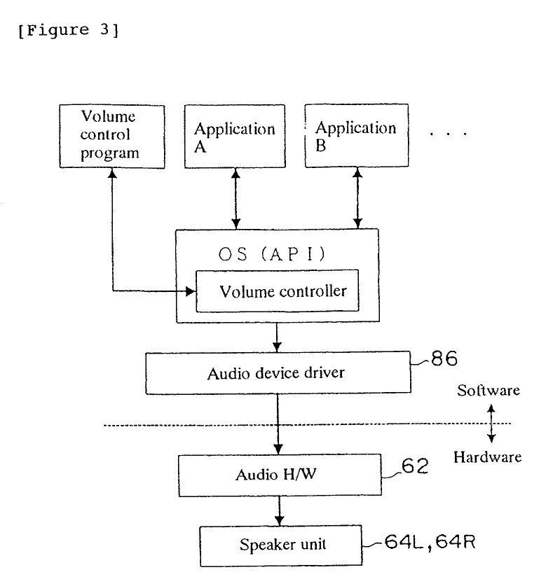

FIG. 3 shows application programs installed in the computer system 10 as “application A” and “application B.” For example, if the “application A” is used for a processing that accompanies the output of voices/sounds from the speakers 64L and 64R, voice data representing the output voices/sounds is output from the speakers 64L and 64R when the CPU 14 executes the “application A.”

This voice data is transferred to the audio H/W 62 under the control of the OS via the audio device driver 86. The OS directs the audio device driver 86 to adjust both volume of the output voices/sounds and the volume balance between right and left speakers according to the present set values of the volume of the output voices/sounds and the volume balance between right and left speakers. The OS manages the set values of both volume of output voices/sounds and volume balance between right and left speakers. Initially, default values are set as those values.

The audio H/W 62, at the time of receiving voice data, converts the voice data to analog voice signals (D/A conversion) of the specified volume and volume balance, then outputs those signals to the speakers 64L and 64R. The audio device driver 86 controls the audio H/W 62 so as to obtain the specified volume and volume balance from the output voices/sounds. Consequently, the voice data output by the “application A” is output from the speakers 64L and 64R and the user can listen to the real voices/sounds in accordance with the volume and volume balance of the present set values.

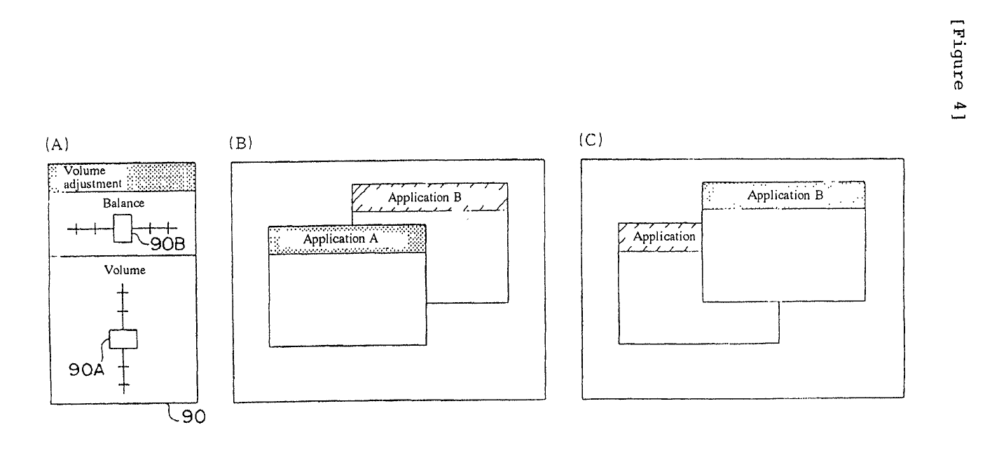

If the volume of voices/sounds output from the speakers 64L and 64R, as well as the volume balance between right and left speakers are decided to be improper, the user of the PC 12 directs so as to display the volume adjusting window. The OS then displays the volume adjusting window 90 on the screen of the LCD 28 as shown in FIG. 4(A). This volume adjusting window 90 displays a graphic image 90A for changing the volume of output voices/sounds and a graphic image 90B for changing the volume balance between right and left speakers respectively.

The position of the graphic image 90A in the volume adjusting window 90 corresponds to the present set value of the volume of output voices/sounds. If the position of the displayed item 90A is moved so as to change the volume of output voices/sounds with use of such a pointing device as a mouse or keyboard, the OS directs the audio device driver 86 so as to change the output volume according to the newly specified position of the graphic item 90A. Consequently, the volume of output voices/sounds from the speakers 64L and 64R is changed according to the direction of the user.

The displayed position of the graphic item 90B in the volume adjusting window 90 corresponds to the present set value of the volume balance between right and left speakers. The user can specify a change of the volume balance by moving the displayed position of the graphic item 90B. The OS then directs the audio device driver 86 to change the volume balance so as to set a value in correspondence to the newly displayed position of the graphic item 90B. Consequently, the volume balance between right and left speakers of voices/sounds output from the speakers 64L and 64R is changed according to the user's specification.

Furthermore, if a change of the volume or volume balance is specified as described above, the OS updates the set value of the specified item, which is managed by itself. These set values are held until at least a change of either the volume or volume balance is specified next time. Voices/sounds are thus output from the speakers 64L and 64R with the volume and the volume balance in accordance with the set values until at least one of those items is changed regardless of the type of the application program executed by the CPU 14.

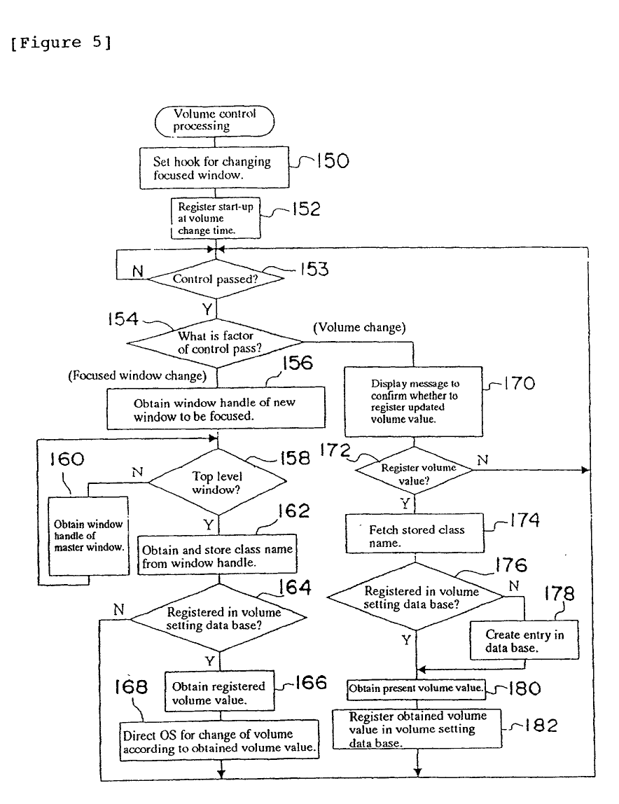

Next, a description will be made for a volume control processing with reference to the flow chart in FIG. 5. The processing is executed by the CPU 14 with use of the volume control program. The volume control program is programmed so as to be started up when the OS is started up and reside in the main memory 16. The volume control program is also programmed so as to pass control to step 150 when the OS issues an event. In steps 150 and 152, the items related to volume control program are initialized (so as to set up an operation environment for the volume control program).

Specifically, control is passed to the volume control program when the focused window displayed on the screen of the LCD 28 is changed over to another (the foreground window is changed over to another) (refer to FIG. 4(B) and (C)). In case of the API (Application Program Interface) supplied by such the subject OS as Windows98, NT, etc., a message (ex., such a window message as WM_SETFOCUS) is output to notify the corresponding application program that a new window is focused (displayed on the foreground) in response to the direction from the application program for a window change.

Consequently, the processing in step 150 is executed when a message is hooked so as to notify a given application program of a change of focused windows from the OS. Consequently, each time the OS changes a focused window to another and the OS sends a message of the change to the volume control program, control is passed to the volume control program.

After this, the processing in step 152 is executed so as to pass control to the volume control program if the volume of the output voices/sounds from the speakers 64L and 64R is changed. The API of such an OS as Windows98, NT, or the like provides an interface used to register a program to which control should be passed when set values for the volume of output voices/sounds and/or the volume balance between speakers are updated through the volume adjusting window 90. (Specifically, the above program can be registered with use of “mixerOpen( ).”) The processing in step 152 can be executed with use of this interface. Control is then passed to the volume control program each time the set values for both volume and volume balance of output voices/sounds are changed through the volume adjusting window 90.

After the volume control program items are initialized as described above (to set up a volume control program operation environment) in steps 150 and 152, the system waits for a control pass to a volume control processing (step 153).

If the OS changes the focused window to another in response to the startup of a specific application program or a click on a window displayed on the background of the screen of the LCD 28, the OS hooks a message to notify the specific application program of the change of the focused window. Then, the OS sends the message to the volume control program, so that control is passed to the volume control program. In this case, control goes from step 153 to step 154, where it is determined why control has been passed to the volume control program, thereby the processing is branched according to the decision.

If such a focused window change is the factor for having caused control to be passed to the volume control program, control goes to step 156. A processing is then executed so as to obtain information for identifying the application program corresponding to a new window to be focused in and after step 156. Specifically, a window handle (ID for identifying a window) is obtained for the new window focused in step 156.

In the case of the API supplied by such an OS as Windows98, NT, etc., if an application program attempts to display a window on the screen, the application program specifies a class name (to be described later in detail) and asks the OS for generating the specified window. Upon such a request from the application program, the OS generates the specified window (executing a preparatory processing to secure a screen area for displaying the window) and gives an arbitrary ID (window handle) to the window. The given window handle is notified to the application program. This window handle is used to identify the subject window when messages are exchanged between the application program and the OS so as to execute a processing (for example, to specify characters and background color, etc.) in the generated window.

Consequently, referencing to the destination of the message (for notifying a change of the focused window) received from the OS, the application program can obtain the window handle of the window to be newly focused in step 156. In step 158, the application program inquires the OS about whether or not the window corresponding to the obtained window handle is a top level one.

If an application program displays a plurality of windows, the program generally manages those windows on the basis of the master-slave relationship. For example, when an application program displays a plurality of windows on the screen, if one of those windows is clicked with a mouse, a plurality of windows are displayed on the foreground simultaneously in some cases. This is because the OS makes good use of the master-slave relationships among those windows. Another example are scroll bars, buttons, etc. existing in a work space of the subject application program. Each of those item is one of the window display types. They are slaves of the window displaying the whole work space. Generally, a hierarchical structure is employed for displaying the windows of each application program as described above.

Each window is given a window handle by the OS and a class name by each application program. The OS thus manages the window handle and the class name of each window, as well as the hierarchical structure (up-down relationship) among those windows. In addition, the Os can specify a given class name for each window. Generally, however, a peculiar name is set for the top level window by each application program.

In this embodiment, because a class name is used to identify each application program, it is required in step 158 to decide whether or not each window is the top level one so as to obtain a class name peculiar to each application program. If the decision in step 158 is NO, control goes to step 160 so as to obtain a window handle of the master window (an upper-rank window related to the above window) corresponding to the present obtained window handle. After that, control returns to step 158. The processings in steps 158 and 160 are repeated until the decision in step 158 becomes YES.

If the window handle of the top level window is obtained, the decision in step 158 becomes YES. Control then goes to step 162 so as to enable the class name given to the top level window to be obtained according to the window handle of the top level window. The class name is notified by the OS upon an inquiry. Then, the obtained class name can be stored in the main memory 16 as information for identifying the application program corresponding to the present focused window (hereafter, to be referred to application ID information simply). The processings in the above steps 156 to 162 correspond to those of the detecting device of the present invention.

In the next step 164, a volume setting data base (setting table) is referenced with use of application ID information as a key so as to decide whether or not both corresponding volume and volume balance values are already registered. The volume setting data base will be described later in detail. If the decision in step 164 is NO, control is passed to the OS and kept there until control is passed again to the volume control program (step 153). Therefore, both volume and volume balance of output voices/sounds are not changed. With the above processings, the application ID information stored in the main memory 16 is updated each time the focused window is changed. And accordingly, it comes to be checked whether or not the corresponding volume value is registered in the volume set data base.

Furthermore, while the CPU 14 executes a specific application program, if the user specifies display of the volume adjusting window 90 and moves the position of the graphic item 90A or 90B so as to obtain proper volume and volume balance of output voices/sounds from the speakers 64L and 64R because of a decision that both volume of output voices/sounds from the speakers 64L and 64R and volume balance between right and left speakers are improper, then the OS passes control to the volume control program according to the result of the processing in step 152. In this case, because the factor of the control pass is changed because of both volume and volume balance, control goes from steps 154 to 170.

In step 170, the screen of the LCD 28 displays a message for confirming the user about whether or not the updated volume and volume balance values are registered as proper volume and volume balance values for executing the present application program. The user thus selects YES or NO. In step 172, it is decided whether or not the user has specified so as to register the updated volume and volume balance values. If the decision is No, control is returned to the OS with no operation and kept there until control is passed again to the volume control program (step 153).

The confirmation of whether or not the updated volume (or volume balance) value is to be registered as described above may also be done in the volume adjusting window 90, for example, by composing the volume adjusting window 90 so that the user can update the volume and volume balance values, then specify registration of the updated volume and volume balance values instead the fact that it is made by displaying messages on the display screen after volume or volume balance is changed.

On the other hand, if it is specified to register updated volume and volume balance values, the decision in step 172 becomes YES and control goes to step 174 so as to fetch the application ID information (class name: as described above, this application ID is updated in step 162 each time the focused window is changed) stored in the main memory. In the next step 176, it is decided whether or not the fetched application ID information is already registered in the volume setting data base.

The volume setting data base (setting table) is handled as non-volatile information in the volume control program. The volume setting data base may also be stored so as to store it in the system. The CMOS 58 and the external storing medium 70 may also be used to store the data base. And, according to the characteristics and contents of the information, the data base may be divided into some places. A plurality of such volume setting data bases may also be stored so that application ID information corresponds to proper volume and volume balance values assumed when the application program corresponding to the application ID information is executed. Because no information is stored in the data base initially, the decision in step 176 becomes NO and control goes to step 178 so as to generate an entry for storing the application ID information, as well as both volume and volume balance values before control goes to step 180.

In step 180, the present volume and volume balance values (updated values decided to be proper by the user) are obtained. In the next step 182, the obtained volume and volume balance values are registered in the entry generated in step 178 in the volume setting data base so as to be corresponded to the application ID information fetched in step 174. The processing in step 182 is executed to end the volume control processing and return control to the OS. The processings in steps 170 to 182 correspond to those of the setting device of the present invention.

Thereby, the decision in step 164 becomes YES and control goes to step 166 if a window corresponding to the application program whose volume and volume balance values are registered in a volume setting data base as described above is defocused, then focused again or if the power of the computer system 10 is turned off, then turned on and the application program is started up.

In step 166, the volume and volume balance values registered in the volume setting data base so as to be corresponded to application ID information are obtained. In the next step 168, the OS is requested to change the set values of both volume of output voices/sounds and volume balance between right and left speakers according to the obtained volume and volume balance values. Consequently, voices/sounds output from the speakers 64L and 64R are controlled automatically so as to become appropriate to the volume and volume balance preferred for the application program corresponding to the newly focused window via the OS, the audio device driver 86, and the audio H/W 62. The processings in steps 164 to 168 as described above correspond to those of the controlling device of the present invention.

If the user changes the set values of both volume and volume balance and specifies registration of the updated volume and volume balance values in the volume setting data base while an application program for which both volume and volume balance values are already registered in the volume setting data base is executed, then the decision in step 176 becomes YES. Consequently, the volume and volume balance values for the currently running application program are overwritten with the updated volume and volume balance values so as to be updated.

In the above case, the user is requested to confirm whether to register the updated volume and volume balance values if those volume and volume balance values are updated while a specific application program is running. Those updated volume and volume balance values are registered only when the registration is specified. However, the present invention is not limited only to that; for example, the updated volume and volume balance values may be registered automatically when the user enters some information (for example, while such a specific key as the CTRL or the like on the keyboard is held down), etc. or a list of application programs installed in the computer system 10 may be displayed so that the user is requested so as to specify proper volume and volume balance values for each of those application programs.

Furthermore, in the above case, only one volume setting data base in which proper volume and volume balance values are registered for each application program is used to control both volume and volume balance of output voices/sounds. However, the present invention is not limited only to that; for example, a volume setting data base may be generated for each user who uses the computer system 10 or for each scene (for example, in an office, at home, at a commuting time, or the like) in which the user uses the computer system 10 and the volume setting data base is changed in accordance with the current user who is using the computer system 10 or the current scene in which the user uses the computer system 10.

Furthermore, in the above case, system parameters are updated/controlled for each application program installed in the computer system 10. However, the present invention is not limited only to that; for example, system parameters may be updated/controlled for each software, such as an OS, a BIOS, a device driver, etc., of course.

Furthermore, in the above case, an application layer program (volume control program) is used to execute various functions of the present invention, that is, the function (function A) for detecting a change of application programs, a function (function B) for confirming the user about whether to register updated volume and volume balance values in a volume data base, a function (function C) for managing the volume data base, a function (function D) for detecting updated volume and volume balance values, and a function (function E) for directing a change of volume and volume balance values of output voices/sounds. However, the present invention is not limited only to that; for example, if it is possible to modify the OS program itself, the functions A to E may be all embedded in the OS.

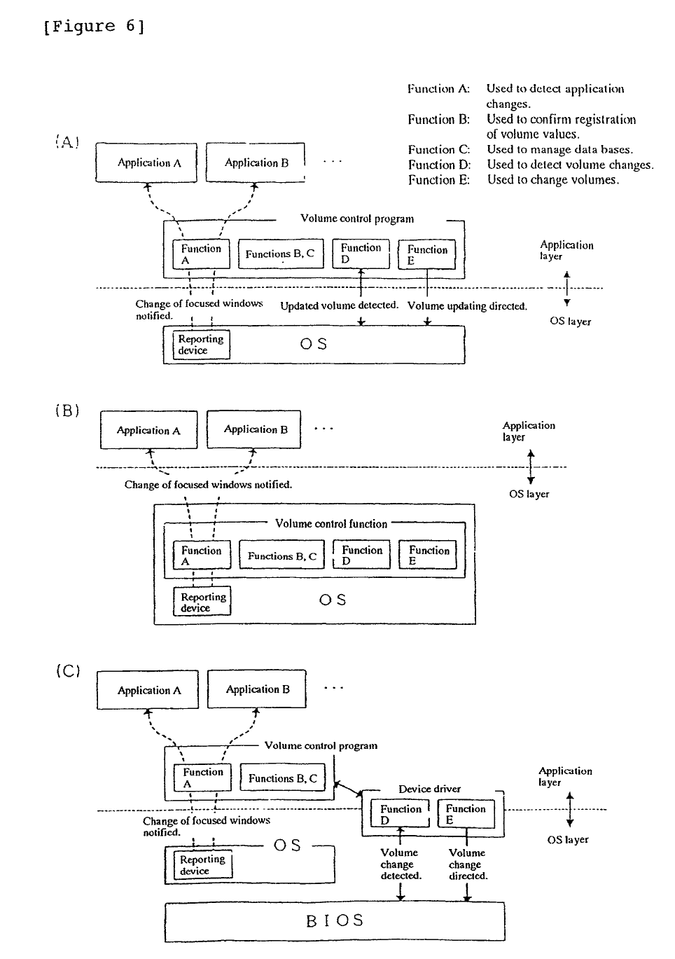

In some cases, the PC is provided with a volume adjusting mechanism separately from the volume adjusting function of the OS. This volume adjusting mechanism enables the BIOS to be started up when specific keys (for example, the “CTRL” key and “Page Up” or “Page Down” key) are pressed, so that the volume is changed according to the operations of those keys independently of the OS and the updated volume value is displayed on the screen. The above volume adjusting mechanism uses a device driver, for example, to monitor and detect whether the above specific keys are pressed. The mechanism is composed so as to change the volume via the BIOS with use of a special (usually not disclosed) interface supplied by the BIOS. In such the mechanism, for example, functions D and E as shown in FIG. 6(C) can be embedded in the device driver so as to realize the present invention with use of the special interface.

Furthermore, if the OS program itself can be modified, the same functions as the functions D and E shown in FIG. 6(C) can be embedded in the OS together with other functions A to C as shown in FIG. 6(B) so as to realize the present invention with use of the special interface.

In the above embodiment, the volume value (volume control parameter) of voices/sounds output from speakers 64L and 64R and the volume balance value between right and left speakers (volume balance control parameter) are used as system parameters related to the environment for the computer's software execution. However, the present invention is not limited only to that; for example, like the volume in each of plural audio frequency bands, and parameters or the like used for converting digital audio data to analog audio signals the system parameter of the present invention may be a parameter related to a sound quality of output voices/sounds (sound quality control parameter), a parameter for specifying a brightness of the screen of the LCD 28 (brightness control parameter), a parameter for specifying an operation speed of the CPU 14 (operation speed control parameter), etc.

In the above embodiment, the volume control program used to realize the method for controlling the computer of the present invention is stored in the information storing medium 70, which is a recording medium of the present invention, so that the program is installed in the computer system 10 in this embodiment from the information storing medium 70 so as to be executed, thereby the computer system 10 functions as the computer of the present invention. The program, however, may be stored in a storing device of another information processing device (e.g., a network server) connected to the computer system 10 via a communication medium (an optical fiber or a wireless line) in a public telephone line and a computer network (e.g., a LAN, the Internet, a wireless communication system, etc.) system at the beginning, then it is transferred to the computer system 10 from the information processing device via the communication medium (transmitting medium of the present invention) through communications with the information processing device, thereby the computer system 10 installs the received program in such a storing device as the HDD 40 or the like so as to execute it so as to function as the computer of the present invention.

As described above, according to the present invention, a proper value of each system parameter related to an environment for a computer's software execution is set for each program, which is to be executed by the computer and the software program executed by the computer is detected and the environment is controlled on the basis of the proper value of each system parameter set in accordance with the detected software program. Consequently, it is possible to control the environment for the computer's software execution appropriately to the subject software program executed by the computer.

While the invention has been described in detail herein in accord with certain preferred embodiments thereof, many modifications and changes therein may be effected by those skilled in the art. Accordingly, it is intended by the appended claims to cover all such modifications and changes as fall within the true spirit and scope of the invention.

Description of Symbols

10 . . . Computer System

14 . . . CPU

62 . . . Audio H/W

64L, 64R . . . Speaker

86 . . . Audio Device Driver

What is claimed is:

1. an apparatus for controlling a computer, said apparatus comprising:
setting means for setting a value of one or more system parameters in association with one or more software programs, said one or more system parameters being related to an environment for said computer's software execution; and
detecting means for detecting one of said one or more software programs being executed by said computer; and
controlling means for controlling said environment for said computer's software execution according to said one or more system parameter values set in association with said detected software program.

2. The apparatus of claim 1, wherein said one or more system parameters are selected from the group consisting of a volume control parameter for specifying a volume of sounds output from speakers of said computer, a volume balance control parameter for specifying a volume balance of said output sounds, a tone quality control parameter for specifying a tone quality of said output sounds, a brightness control parameter for specifying a brightness of a screen of a computer display, and a clock speed control parameter for defining clock speed of a CPU in said computer.

3. The apparatus of claim 1, wherein said detecting means detects a software program activating a corresponding window displayed on a display screen of said computer as a software program executed by said computer.

4. The apparatus of claim 1, wherein said setting means automatically sets said value(s) of said one or more system parameters in association with a specific software program if any one of said one or more system parameters is updated in response to a user command while said computer executes said specific software program.

5. The apparatus of claim 1, wherein if a user selects a specific software program and specifies a value for one of said one or more system parameters, said setting means sets said specified value for said one of said one or more system parameters, in association with said specific software program.

6. The apparatus of claim 2,
wherein said setting means further comprises a plurality of tables, each of said tables potentially containing a value of said one or more system parameters set in association with one of said one or more software program; and
wherein said controlling unit controls said environment for said computer's software execution according to said value of said one or more system parameters set in a specified setting table.

7. A method for controlling a computer, comprising the steps of:
(a) setting a value of one or more system parameters in association with one or more software programs, said one or more system parameters being related to an environment for said computer's software execution; and
(b) detecting one of said one or more software programs being executed by said computer; and
(c) controlling said environment for said computer's software execution according to said one or more system parameter values associated with said detected software program as a result of said setting.

8. The method of claim 7, wherein said one or more system parameters are selected from the group consisting of a volume control parameter for specifying a volume of sounds output from speakers of said computer, a volume balance control parameter for specifying a volume balance of said output sounds, a tone quality control parameter for specifying a tone quality of said output sounds, a brightness control parameter for specifying a brightness of a screen of a computer display, and a clock speed control parameter for defining clock speed of a CPU in said computer.

9. The method of claim 7, wherein said detecting comprises identifying one of said one or more software programs activating a corresponding window displayed on a display of said computer.

10. The method of claim 7, wherein said setting comprises automatically associating said one or more system parameter values with one of said one or more software programs if any one of said one or more system parameters is updated in response to a user command while said computer executes said one of said one or more software programs.

11. The method of claim 7, wherein said setting comprises responding to a user selecting one of said one or more software programs and specifying a value of said one or more system parameters, by associating said user specified parameter value with said user selected software program.

12. At least one program storage device readable by a machine, tangibly embodying at least one program of instructions executable by the machine to perform a method of controlling a computer, said method comprising:
(a) setting a value of one or more system parameters in association with one or more software programs, said one or more system parameters being related to an environment for said computer's software execution; and
(b) detecting one of said one or more software programs being executed by said computer; and
(c) controlling said environment for said computer's software execution according to said one or more system parameter values associated with said detected software program as a result of said setting.

13. The at least one program storage device of claim 12, wherein said one or more system parameters are selected from the group consisting of a volume control parameter for specifying a volume of sounds output from speakers of said computer, a volume balance control parameter for specifying a volume balance of said output sounds, a tone quality control parameter for specifying a tone quality of said output sounds, a brightness control parameter for specifying a brightness of a screen of a computer display, and a clock speed control parameter for defining clock speed of a CPU in said computer.

14. The at least one program storage device of claim 12, wherein said detecting comprises identifying one of said one or more software programs activating a corresponding window displayed on a display of said computer.

15. The at least one program storage device of claim 12, wherein said setting comprises automatically associating said one or more system parameter values with one of said one or more software programs if any one of said one or more system parameters is updated in response to a user command while said computer executes said one of said one or more software programs.

16. The at least one program storage device of claim 12, wherein said setting comprises responding to a user selecting one of said one or more software programs and specifying a value of said one or more system parameters, by associating said user specified parameter value with said user selected software program.
